(19) United States
(12) Patent Application Publication
(10) Pub. No.: US 2006/0208111 A1
(43) Pub. Date: Sep. 21, 2006

(54) Showerhead extension arm

(76) Inventors: Martin Tracy, Whitevale (CA); Peter Colpitts, Uxbridge (CA)

Correspondence Address: MEREK, BLACKMON & VOORHEES, LLC, 673 S. WASHINGTON ST., ALEXANDRIA, WV, 22314, US

(21) Appl. No.: 11/079,073

(22) Filed: Mar. 15, 2005

(51) Int. Cl. B05B 15/08

(52) U.S. Cl. 239/587.2; 239/587.3; 239/587.4; 239/587.5; 239/548

(57) ABSTRACT

A showerhead extension arm comprising a generally tubular body portion, first and second hub members, a showerhead engaging portion, and a shower arm coupling. The first hub member is rotationally secured to a first end of the tubular body portion and the second hub member is rotationally secured to a second end of the tubular body portion. Each of the hub members permit the flow of fluid therethrough. The showerhead engaging portion permits the showerhead extension arm to be secured to a showerhead such that the showerhead is permitted to rotate relative to an axis generally perpendicular to the tubular body portion and to simultaneously rotate relative to an axis generally parallel to the tubular body portion.

### FIELD OF THE INVENTION

This invention relates generally to the field of plumbing accessories, and in particular to a new and improved showerhead extension arm for connecting a showerhead to a water supply conduit.

### BACKGROUND OF THE INVENTION

Due to time and energy savings, showers have become a preferred manner of bathing in many cultures and countries. With the ever increasing popularity of showering, a considerable amount of time and effort has been devoted to the development of various types and forms of showerheads having a variety of different features and physical attributes, ranging from reduced water consumption to pulsating spray patterns providing an invigorating or massaging effect. While a significant emphasis has been placed upon the showerhead design, little effort has been expended on developing showerheads and related devices that accommodate use by individuals of different sizes and physical abilities, and for use in shower stalls of varying dimensions.

To date, devices that aid in the use of a showerhead by individuals of different heights and different physical abilities and requirements have generally been limited in the use of a vertical pipe or rail onto which a showerhead may be releasably secured at different elevations. The positioning of the showerhead at different elevations is commonly accommodated through the use of a flexible supply line or hose used to connect the showerhead to a water supply or conduit in the adjacent wall. More recently others have proposed the use of rigid or flexible extensions that are connectable to the showerhead and to the water supply conduit, and that permit the showerhead to be positioned at a lower elevation than if the showerhead were fixed directly to the supply conduit at the point that it passes through the shower wall. Unfortunately, such prior devices have proven to be of only marginal assistance in practice. Where the extension arm is fixed, the relative height of the showerhead is not adjustable once the showerhead and extension arm have been threaded or otherwise connected together. In the case of currently available adjustable extension arms, their structures are severely limited in terms of their ability to allow a user to orient a showerhead in different positions. For example, currently available extension arms are generally only capable of rotating through a range of from about 60 to 70 degrees. With larger “rainfall” type showerheads experiencing widespread popularity, the ability to position the head in a horizontal plane over the head of a user is becoming increasingly important. Unfortunately, available extension arms are limited in their ability to increase the height of the showerhead above the position where the supply conduit passes through the wall. Similarly, such devices are generally inefficient in presenting a means to lower the elevation of the showerhead to accommodate a shorter individual or child. Even where available extension arms allow for increasing or decreasing the elevation of the showerhead, they often fail to permit the head to be easily positioned in a horizontal plane at its new elevation. Currently available adjustable extension arms also tend to be somewhat clumsy to use, often utilizing wing nuts or similar structures that hinder the re-positioning of a showerhead, particularly for elderly people or persons with physical limitations or disabilities. In addition, the utilization of currently available extension arms typically results in the showerhead being offset by a considerable distance from the shower wall, an attribute that may not be desirable in smaller shower stalls or enclosures.

### SUMMARY OF THE INVENTION

The invention therefore provides a showerhead extension arm that is both simple to use and that provides the ability to position a showerhead over an enhanced range of positions and locations within a shower stall or enclosure.

Accordingly, in one of its aspects the invention provides a showerhead extension arm comprising a generally tubular body portion having an internal passageway to permit the flow of fluid therethrough; first and second hub members, said first hub member rotationally secured to a first end of said tubular body portion and said second hub member rotationally secured to a second end of said tubular body portion, each of said hub members permitting the flow of fluid therethrough; a showerhead engaging portion rotationally secured to said first hub member and permitting said showerhead extension arm to be secured to a showerhead such that said showerhead is permitted to rotate relative to an axis generally perpendicular to said tubular body portion and to simultaneously rotate relative to an axis generally parallel to said tubular body portion; and, a shower arm coupling rotationally secured to said second hub member and releasably securing said extension arm to a water supply conduit such that water from said conduit is permitted to flow through said shower arm coupling, through said second hub member, through said tubular body portion, through said first hub member, through said showerhead engaging portion and into said shower head.

In a further aspect the invention provides a showerhead extension arm for connecting a showerhead to a water supply conduit, the showerhead extension arm comprising a generally tubular body portion having an internal passageway to permit the flow of water therethrough; first and second hub members, said first hub member rotationally secured to a first end of said tubular body portion to permit rotation of said first hub member relative to axis generally perpendicular to the longitudinal axis of said tubular body portion, said second hub member rotationally secured to a second end of said tubular body portion to permit rotation of said second hub member relative to axis generally perpendicular to the longitudinal axis of said tubular body portion; a showerhead engaging portion to secure said showerhead to said first hub member and permitting said showerhead to rotate relative to axis generally perpendicular to the axis of rotation of said first hub member about said tubular body portion; and, a shower arm coupling releasably securable to said water supply conduit and rotationally secured to said second hub member to permit rotation of said shower arm coupling relative to an axis generally perpendicular to the axis of rotation of said second hub member about said tubular body portion.

In another aspect the invention concerns a showerhead extension arm for connecting a showerhead to a water supply conduit, the showerhead extension arm comprising a generally tubular body portion having an internal passageway to permit the flow of water therethrough; a showerhead engaging portion to secure said showerhead to said tubular body portion, a hub member secured to said tubular body portion; and, a shower arm coupling releasably securable to said water supply conduit and rotationally secured to said hub member, said hub member and said shower arm coupling together permitting the simultaneous rotation of said tubular body member, and said showerhead attached thereto, relative to both an axis that is generally perpendicular to the longitudinal axis of said tubular body portion and relative to an axis that is generally parallel to the longitudinal axis of said tubular body portion.

Further aspects and advantages of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show the preferred embodiments of the present invention in which:

FIG. 1 is a side elevational view of a bathtub and shower enclosure having installed therein a showerhead extension arm in accordance with one of the preferred embodiments of the present invention;

FIG. 2a is a side elevational view of the showerhead extension arm shown in FIG. 1 having a showerhead attached to one end thereof;

FIG. 2b is a side elevational view of the showerhead extension arm of FIG. 2a wherein the extension arm has been manipulated to enable the showerhead to be drawn closer to the wall of the shower;

FIG. 3 is a bottom view of the showerhead extension arm and showerhead shown in FIG. 2a;

FIG. 4 is a sectional view taken along the line 4-4 of FIG. 3;

FIG. 5 is an upper side perspective view of the showerhead extension arm and showerhead shown in FIG. 1 wherein the arm has been adjusted such that it is hidden behind the showerhead;

FIG. 6a is a plan view of a male portion of the tubular body portion of the showerhead extension arm shown in FIG. 1;

FIG. 6b is a sectional view taken along the line 6b-6b of FIG. 6a;

FIG. 6c is a side elevational view of the male portion of the tubular body portion shown in FIG. 6a;

FIG. 7a is a plan view of a female portion of the main tubular body portion of the showerhead extension arm shown in FIG. 1;

FIG. 7b is a sectional view taken along the line 7b-7b of FIG. 7a;

FIG. 7c is a side elevational view of the female portion of the main tubular body portion shown in FIG. 7a;

FIG. 8a is a plan view of one of the hub members of the showerhead extension arm shown in FIG. 1;

FIG. 8b is an upper side perspective view of the hub member shown in FIG. 8a;

FIG. 8c is a front elevational view of the hub member shown in FIG. 8a;

FIG. 8d is a sectional view taken along the line 8d-8d of FIG. 8c;

FIG. 9a is a side elevational view of a shower arm coupling used in association with the embodiment of the showerhead extension arm shown in FIG. 1;

FIG. 9b is a bottom view of the shower arm coupling shown in FIG. 9a;

FIG. 9c is a sectional view taken along the line 9c-9c of FIG. 9a;

FIG. 10a is an upper perspective view of the showerhead shown in FIG. 1 wherein the showerhead has its rear cover removed and showing the showerhead engaging portion used in association with the embodiment of the showerhead extension arm shown in FIG. 1;

FIG. 10b is an enlarged detailed view of the structure shown in FIG. 10a;

FIG. 11a is a top plan view of a ratchet locking ring used in association with the embodiment of the showerhead extension arm shown in FIG. 1;

FIG. 11b is a side elevational view of the ratchet locking ring shown in FIG. 11a;

FIG. 11c is a side perspective view of the ratchet locking ring shown in FIG. 11a;

FIG. 11d is an enlarged detail view of a portion of the ratchet locking ring shown in FIG. 11c;

FIG. 12a is a side perspective view of a star washer used in association with the embodiment of the showerhead extension arm shown in FIG. 1;

FIG. 12b is a plan view of the star washer shown in FIG. 12a;

FIG. 13a is a plan view of a hub insert used in association with the embodiment of the showerhead extension arm shown in FIG. 1;

FIG. 13b is an upper side perspective view of the hub insert shown in FIG. 13a;

FIG. 13c is a side elevational view of the hub insert shown in FIG. 13a;

FIG. 13d is a sectional view taken along the line 13d-13d of FIG. 13c;

FIG. 14a is a side elevational view of a coupling insert used in association with the embodiment of the showerhead extension arm shown in FIG. 1;

FIG. 14b is a sectional view taken along the line 14b-14b of FIG. 14a;

FIG. 15 is an alternate embodiment of the extension arm of the present invention wherein the first and second hub members attached to the tubular body portion are double swivel ball joints;

FIG. 16 is an alternate embodiment of the extension arm of the present invention wherein the second hub member attached to the tubular body portion is a double swivel ball joint; and,

FIG. 17 is an alternate embodiment of the extension arm of the present invention wherein the tubular body portion is generally C-shaped and the first and second hub members attached to the tubular body portion are double swivel ball joints.

### DESCRIPTION OF THE PREFERRED EMBODIMENT

The present invention may be embodied in a number of different forms. However, the specification and drawings that follow describe and disclose only some of the specific forms of the invention and are not intended to limit the scope of the invention as defined in the claims that follow herein.

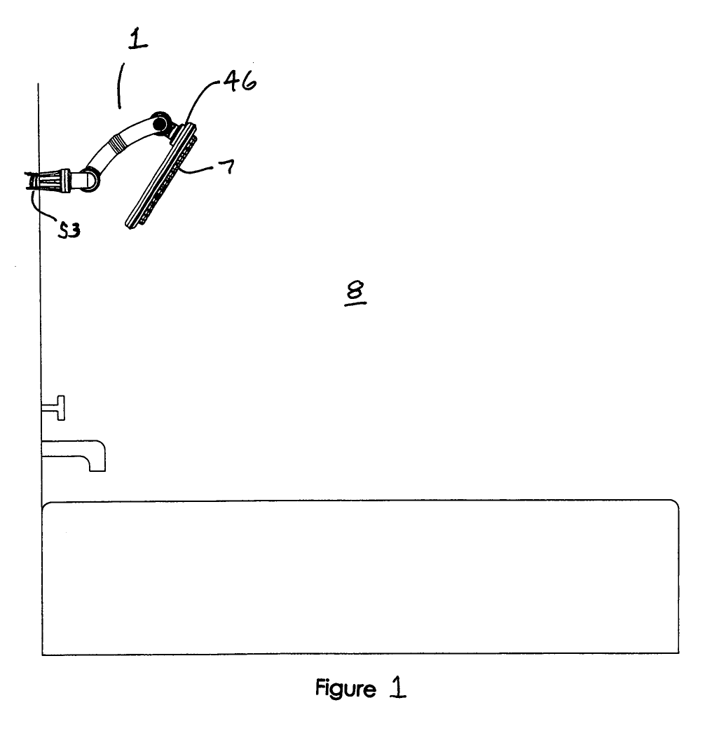

A showerhead extension arm constructed in accordance with one the preferred embodiments of the present invention is shown in the attached drawings and noted generally by reference numeral 1. In the embodiment of the invention shown in the drawings showerhead extension arm 1 is comprised primarily of a generally tubular body portion 2, first and second hub members 3 and 4, a showerhead engaging portion 5 and a shower arm coupling 6. Referring to FIG. 1, there is shown a showerhead extension arm 1 having a showerhead engaging portion 5 attached to a showerhead 7 and with a shower arm coupling 6 connected to a water supply conduit 53 that would typically comprise a threaded nipple passing outwardly from the side of shower stall 8. As will be described in greater detail, the utilization of shower extension arm 1 to attach or connect showerhead 7 to a water supply conduit in a shower stall will enable the showerhead to be positioned in a large number of different physical locations about the conduit, and subsequently re-positioned to different locations depending upon the needs and desires of an individual user.

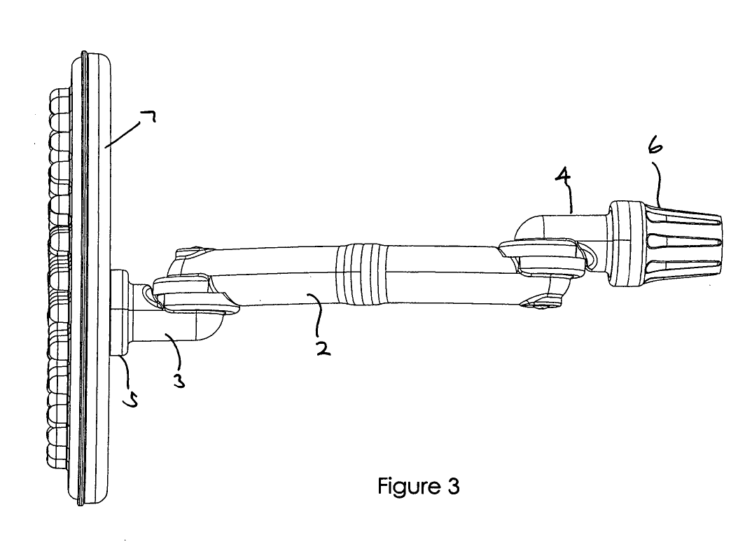

With specific reference to FIGS. 1 through 5, tubular body portion 2 has an internal passageway 9 that permits the flow of water or fluid therethrough. In the preferred embodiment tubular body portion 2 is comprised of a elongate pipe-like structure having an internal hollow bore. In one embodiment the tubular body portion may be slightly curved or arcuate in shape. Tubular body portion 2 has a first end 10 to which first hub member 3 is rotationally secured and a second end 11 to which second hub member 4 is rotationally secured. Each of hub members 3 and 4 are also formed with internal hollow passageways 12 that, when the respective hub members are rotationally secured to the first and second ends of tubular body portion 2, co-operate with internal passageway 9 through the tubular body portion to permit water to flow through the assembled structure.

As shown in the attached drawings, showerhead engaging portion 5 is secured to first hub member 3 and serves as the mechanism by which showerhead 7 is attached or secured to the showerhead extension arm. In addition, and as in the case of the attachment of the hub members to tubular body portion 2, in the preferred embodiment showerhead engaging portion 5 is preferably rotationally secured to first hub member 3 to enable the showerhead attached thereto to rotate relative to the hub member. Further, shower arm coupling 6 is preferably rotationally secured to second hub member 4 and is designed to be releasably securable to a water supply conduit.

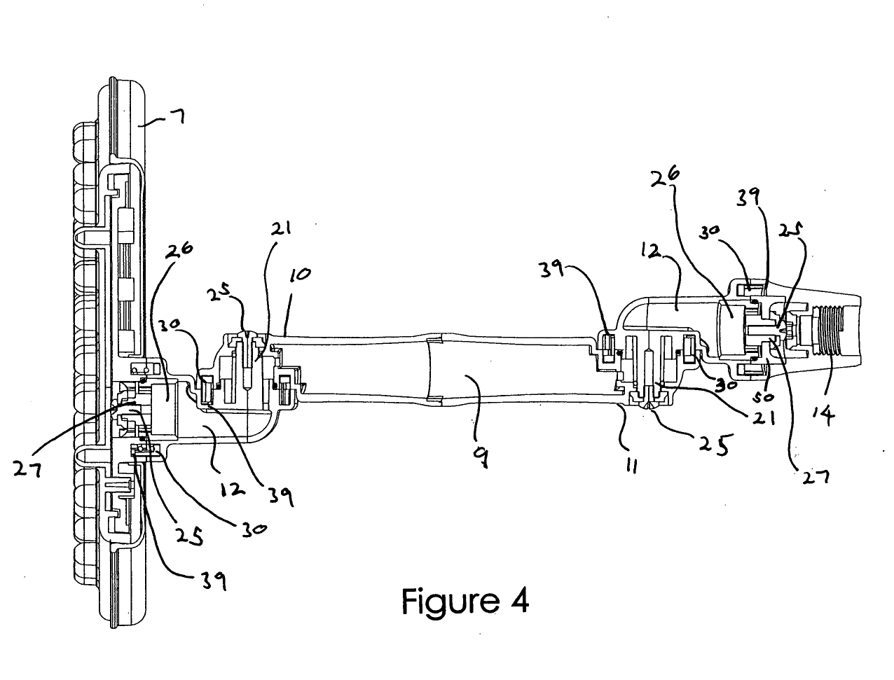

It will be appreciated by those skilled in the art that a variety of different mechanisms could be utilized to secure the shower arm coupling to a water supply conduit. In the embodiment shown in the attached drawings, the shower arm coupling 6 has an internal threaded bore 14 that permits it to be threaded onto the end of a comparably threaded supply conduit. Alternately, the shower arm coupling could be glued, crimped or soldered onto the supply conduit, or could be secured by means of a variety of other mechanical fastening mechanisms. As is shown in FIG. 4, shower arm coupling 6 preferably includes a hollow passageway 13 that co-operates with the hollow passageway 12 in second hub member 4 such that when the showerhead extension arm is secured to a water supply conduit, water from the conduit is permitted to flow through shower arm coupling 6, through second hub member 4, through tubular body portion 2, through first hub member 3, through showerhead engaging portion 5, and eventually into showerhead 7.

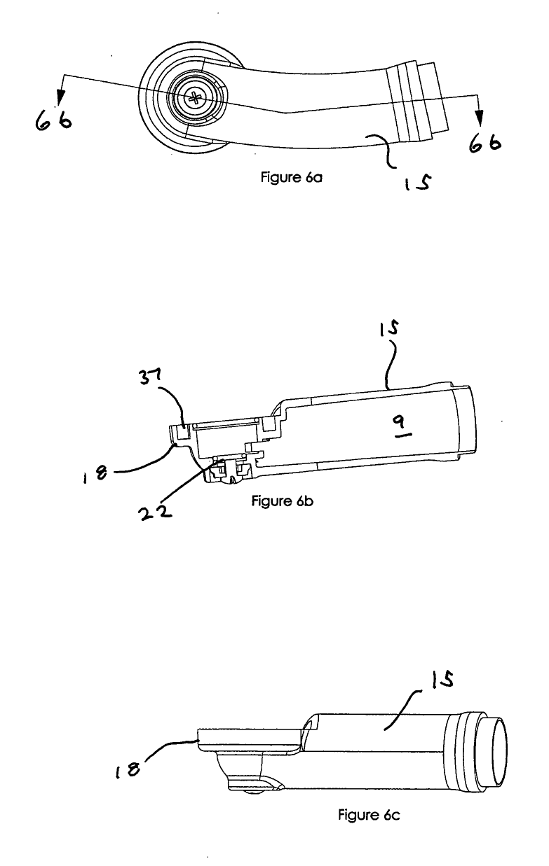

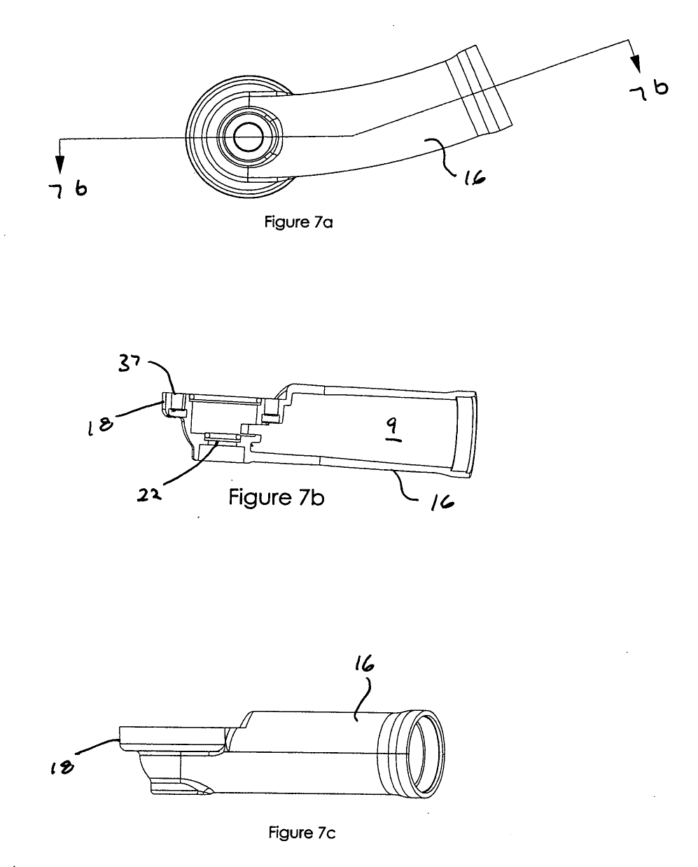

As shown in the attached drawings, extension arm 1 may be constructed of primary and secondary components that are later assembled together into the finished product. Fabricating components in this manner will in most cases be simpler and more cost effective than attempting to construct larger and more complex parts as a single unit., particularly where the parts are molded from plastic. In the embodiment shown in FIGS. 6a through 7c, tubular body portion 1 is formed from a male portion 15 that mates with a corresponding female portion 16. Connecting the male and female portions of the tubular body member together may be accomplished through the use of adhesives, heat welding the parts together, threading the two portions together, or the use of a wide variety of mechanical structures.

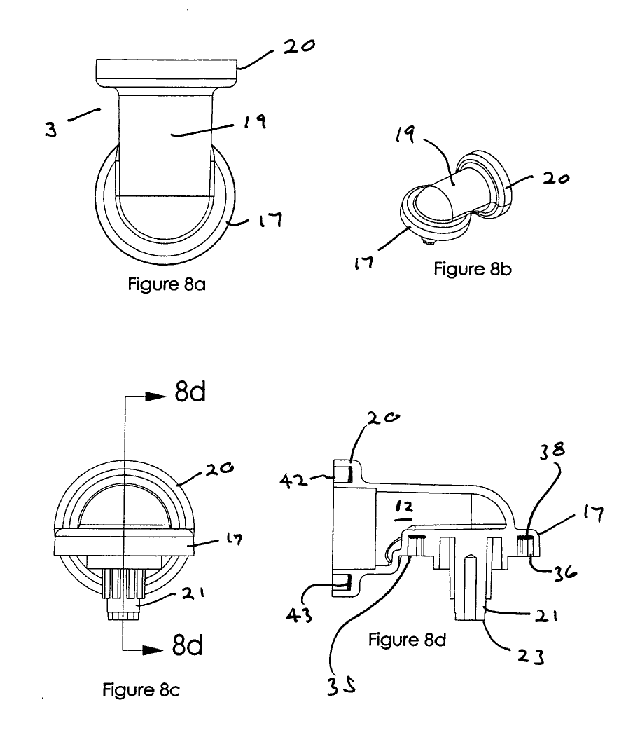

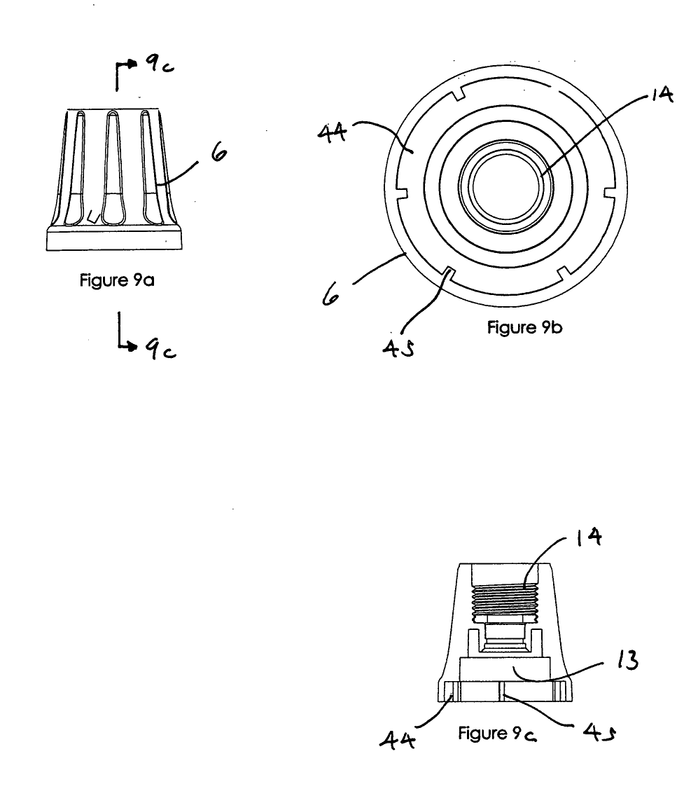

Referring to FIGS. 8a through 8d, there is shown one of the preferred embodiments for the structure of hub portions 3 and 4. In the embodiment shown, the hub portions are generally in the form of a 90 degree elbow having a flange 17 that mates with a correspondingly sized flange 18 on each end of tubular body portion 2. When the hub members are assembled on the tubular body portion (see FIG. 4) flange 18 is generally aligned with flange 17 such that the opening in the central portion of the flange is situated approximately perpendicular to the longitudinal axis of the tubular body portion. Accordingly, mating flange 17 of the hub portion with flange 18 of the tubular body member, in conjunction with the overall configuration of the hub portion in the general form a 90 degree elbow, will result in the main body 19 of the hub portion having a longitudinal axis generally parallel to that of tubular body portion 2. The distal end 20 of the main body of the hub members is also formed with a flange 20 that, as will be described in further detail, assists in securing the hub members to either showerhead engaging portion 5 or shower arm coupling 6, as the case may be.

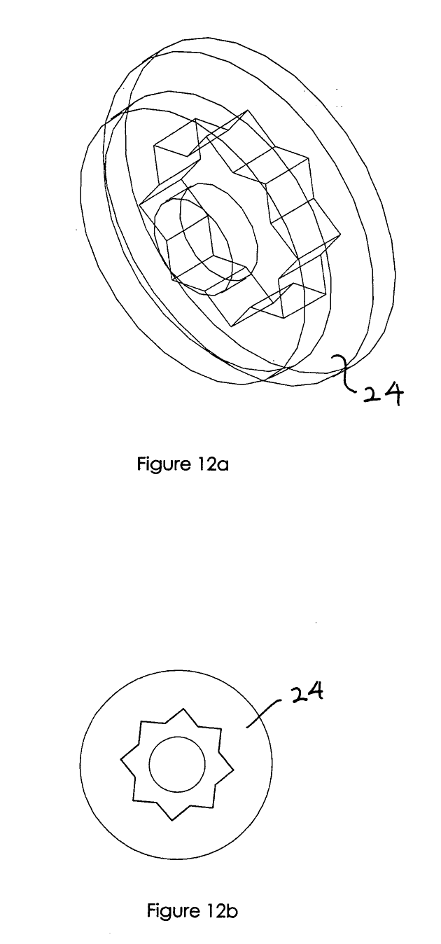

Referring once again to FIGS. 8a through 8d, and also with reference to FIG. 4, in the embodiment of the invention depicted therein there is situated centrally within flange 17 a spigot 21 that is receivable within the hollow interior of tubular body portion 2 and centrally within flange 18 when flanges 17 and 18 are mated together. When the hub is assembled onto the tubular body portion spigot 21 will extend through an open bore 22, and will thus be visible through the tubular body portion (see FIG. 4). The lower end 23 of spigot 21 may be fabricated in the shape of a star or other non-circular geometric shape for receipt within a star washer 24 (see FIGS. 4, 12a and 12b). A bolt, screw or other form of fastener 25 may then be inserted through star washer 24, through bore 22 in tubular body portion 2 and into the central core of spigot 21. The screw, in conjunction with the star washer, will securely hold the spigot in place and hence secure the hub member to the tubular body portion with flanges 17 and 18 adjacent to one another. It will thus be appreciated that in this fashion the hub members may be secured to the tubular body portion while permitting rotational movement of the hubs about an axis that is generally perpendicular to the longitudinal axis of the tubular body portion. As shown in FIG. 4, the internal passageways of the tubular body portion and the hub members co-operate together to form a flow passageway for water to travel through the assembled structure. A series of seals and/or O-rings may be inserted between the hub members and the respective ends of the tubular body portion in order to present a water tight connection.

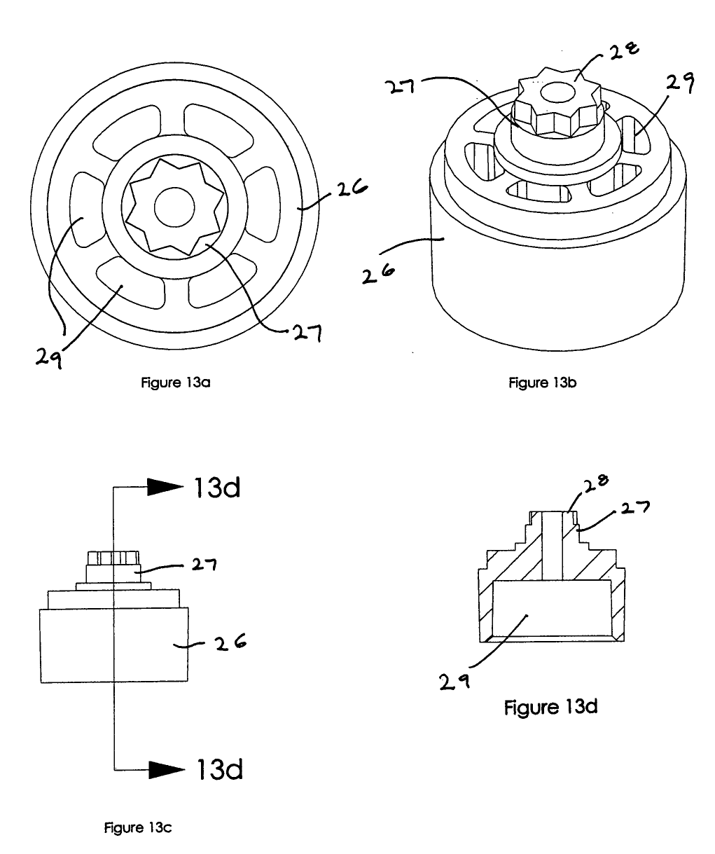

From an appreciation of the manner in which the hub members are secured to opposite ends of tubular body portion 2, it will understood by those skilled in the art with reference to the attached drawings that each of showerhead engaging portion 5 and shower arm coupling 6 are in this embodiment of the invention secured to their respective and associated hub members in essentially the same fashion. To simplify the manufacturing of the hub members, flanges 20 are not formed with centrally positioned spigots as in the case of flange 17. Instead, a hub insert 26 (see FIGS. 13a through 13d) is fabricated to be received within the internal passageway of flange 20. Hub insert 26 may be glued, welded or otherwise secured within the hollow bore centralized within flange 20 on each of hub members 3 and 4.

The hub inserts are formed with spigots 27 having on their lower ends 28 a star or other non-circular structure, essentially the same as described above with respect to spigots 21. With hub insert 26 received within flange 20 of the hub member, spigot 27 may then be inserted into a hollow bore in either shower arm coupling 6 or showerhead engaging portion 5 (as the case may be) to be received therein and securably held in place, once again through the use of a star washer and fastener in the same manner as described above. With the tightening of the fastener in place, the flanges on the hub members will align with corresponding flanges on either the shower arm coupling or the showerhead engaging portion to form an aesthetically pleasing transition and a mechanically stable connection. One or more seals and/or 0-rings may once again be utilized to present a fluid tight connection between the parts. As shown particularly in FIGS. 13a and 13b, a series of flow passageways 29 in hub insert 26 permit fluid to flow from the shower arm coupling into second hub member 2 in one case, and from first hub member 3 into shower engaging portion 5 and into showerhead 7 in the other case.

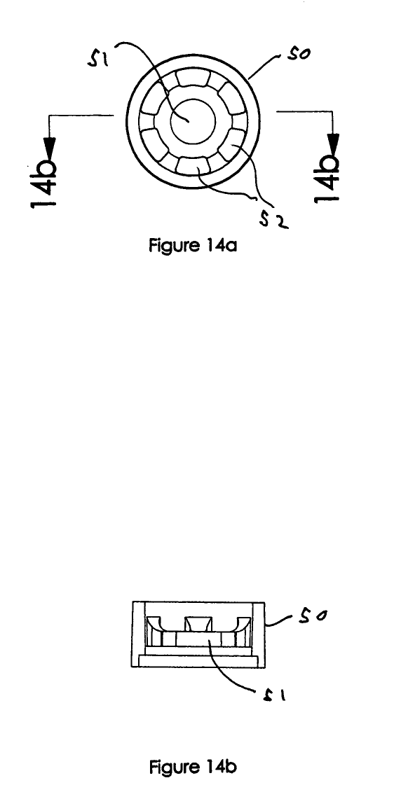

Just as the fabrication of hub inserts for receipt into the internal passageway of flange 20 on the hub members aid in the manufacturing of the hubs, to simplify the manufacturing of the shower arm coupling a coupling insert 50 may be formed for receipt into the coupling's hollow interior. One embodiment of the coupling insert is shown in FIGS. 4, 14a and 14b. Here insert 50 is shown as generally disk shaped and containing a central bore 51 through which the spigot 27 of the hub insert 26 may pass. The coupling insert is preferably glued, welded, or otherwise fixed in place within the interior or the shower arm coupling so that when spigot 27 is inserted therein the coupling insert will provide a surface against which star washer 24 and screw 25 may bear to rotationally secure the shower arm coupling to second hub member 4. A plurality of flow passages 52 extend through the coupling insert to provide a means for water to flow through the coupling and into second hub member 4.

It will thus be understood that the described manner of assembling the primary component parts of showerhead extension arm 1 will permit rotational movement between a number of the different parts and in planes that are generally perpendicular to one another. Specifically, showerhead 7 and showerhead engaging portion 5 are permitted to freely rotate about spigot 27 on hub insert 26 of first hub member 3. Similarly, first hub member 3 is permitted to rotate about an axis along the length of spigot 21 when it is received within first end 10 of tubular body portion 2. Spigot 21 on second hub member 4 permits second hub member 4 to rotate about an axis along the length of the spigot when it is received within the second end 11 of tubular body member 2. Finally, shower arm coupling 6 is permitted to freely rotate about spigot 17 on the hub insert received within second hub member 4.

In this manner, when connected to the showerhead extension arm showerhead 7 is permitted to rotate about an axis generally perpendicular to tubular body portion 2 and simultaneously about an axis generally parallel to the tubular body portion. Stated another way, when assembled in the fashion described first hub member 3 will be rotationally secured to first end 10 of tubular body portion 2 in a manner that permits rotation of the first hub member about an axis generally perpendicular to the longitudinal axis of the tubular body portion. The second hub member 2 will be rotationally secured to second end 11 of tubular body portion 2 in a fashion that permits rotation of the second hub member about an axis that is also generally perpendicular to the longitudinal axis of the tubular body portion. Showerhead engaging portion 5 will be securable to showerhead 7 in a manner that permits the showerhead to rotate about an axis that is generally perpendicular to the axis of rotation of first hub member 3 about tubular body portion 2. Further, shower arm coupling 6 will be releasably securable to a water supply conduit and will be rotationally secured to second hub member 4 in a manner that permits rotation of the shower arm coupling about an axis that is generally perpendicular to the axis of rotation of the second hub member about the tubular body portion.

In the preferred embodiment of the invention that is shown in the attached drawings, each of the points of rotation (ie between the first and second hubs and the tubular body portion, between the first hub member and the showerhead engaging portion, and between the second hub member and the shower arm coupling) are designed so as to permit movement in fixed and incremental amounts or degrees. That is, the design of the rotational connections between the various parts is such that if sufficient force is applied to the extension arm various parts or combinations of parts can be rotated with respect to one another to permit a wide range of positions to which the showerhead may be moved. When the applied force is removed, the rotatable connections preferably lock into place rigidly fixing the location of the showerhead until such time as force is once again applied. In one embodiment the manner of permitting rotational movement of the various parts relative to one another by incremental amounts or degrees is achieved through the use of a ratchet locking member 30 at each rotational juncture. To more fully explain the structure and function of ratchet locking member 30, reference will now be made, by way of example, to the rotational connection of first hub member 3 to tubular body portion 2.

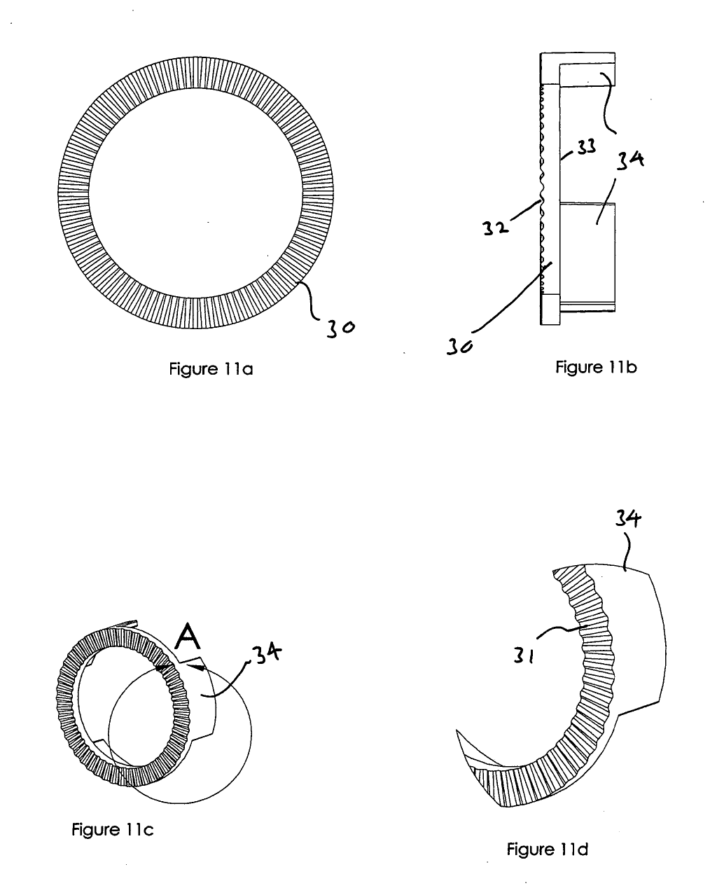

From a thorough understanding of the invention it will be appreciated that ratchet locking member 30 may take a variety of different forms. One of the preferred forms of the ratchet locking member is shown and represented in FIGS. 11a through 11d. Here, the ratchet locking member is comprised generally of a circular or ring-shaped body having a series of ridges or teeth 31 on its outer face 32. The rear surface 33 of the locking member may contain a plurality of outwardly extending tabs 34 that (as will be explained in more detail) served to hold the ratchet locking member in place and to prevent its rotation relative to the housing in which it is situated. In the attached Figures, three such tabs 34 are shown extending from the rear face of the locking member, however, more or less than three tabs could also be used. In addition, a variety of other mechanical structures could be utilized to hold the locking member in place, including the use of adhesives and other permanent bonding methods. It will also be understood that for manufacturing purposes ratchet locking member 30 is a separate and distinct part. In an alternate embodiment the locking member could be an integral portion of other parts of the overall showerhead extension arm.

As shown in FIG. 8d, flange 17 of the hub members contains an internal race 35 into which ratchet locking member 30 may be received with-tabs 34 extending into the race. The tabs are received between internal partitions 36 within the race to thereby prevent rotational movement of the ratchet locking member relative to the hub. With ratchet locking member 30 received within race 35, the front face of the locking member, together with teeth 31, will extend outwardly from the face of flange 17. As shown in FIG. 6b, flange 18 on the tubular body portion (which corresponds to flange 17 on the hub member) also contains an internal race 37.. Race 37 is dimensioned so as to receive the portion of ratchet locking member 30 that extends beyond flange 17 when the hub member is attached to the tubular portion through the receipt of spigot 21 through open bore 22. The bottom of race 37 is preferably formed with teeth 38 that correspond to teeth 31 on ratchet locking member 30. When the hub member is rotationally secured to the tubular body portion teeth 31 of the ratchet locking member will therefore become engaged with teeth 38 within race 37.

To force teeth 31 and 38 into engagement with one another, a biasing member is preferably positioned within race 35 beneath tabs 34 of the ratchet locking member. The biasing member may be any of a wide variety of different spring structures, including spring or belleville washers, coil springs, and compression springs. In addition, it will be appreciated that rather than a separate dedicated spring the biasing member may be comprised of a flexibly resilient flange positioned within race 35. Regardless of its particular structure the biasing member will tend to drive the teeth 31 of ratchet locking member 30 into teeth 38 within the race on the tubular-body portion. With tabs 34 effectively fixing the ratchet locking member within the hub member, rotation of the hub member about the end of the tubular body portion can thus only be achieved through the application of a force that is in excess of the biasing force driving the two sets of teeth together. In this manner, movement of the hub about the end of the tubular body portion can only be accomplished through the application of sufficient force, the removal of which will cause the teeth to be engaged and effectively lock the parts together. For large or heavy extension arms or showerheads it may be desirable to double-up or increase the strength of the biasing members. Increasing the spring constant of biasing member 39 will increase the force tending to hold the various components in their fixed positions and assist in maintaining the showerhead in position during use.

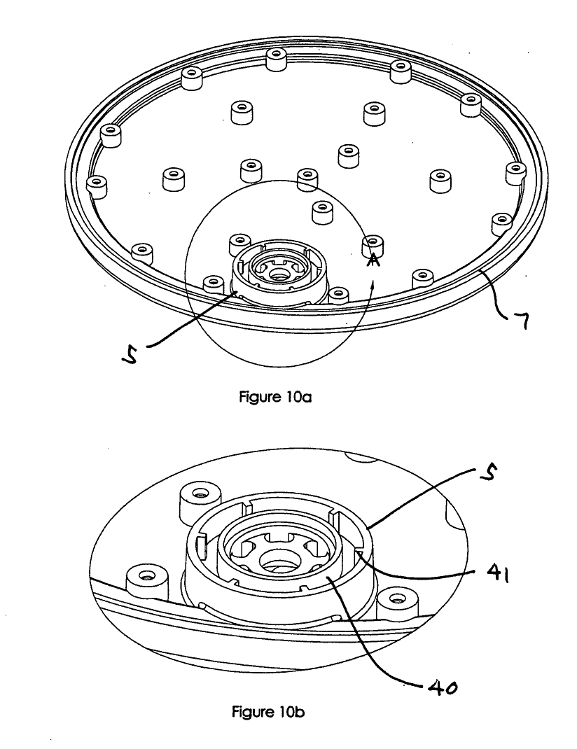

The structure and operation of the ratchet locking member used in association with the showerhead engaging portion and the shower arm coupling is essentially the same as that described above for the hub members. In the case of showerhead engaging portion 5, the component contains an internal race 40 having a series of partitions 41 that together receive tabs 34 on the ratchet locking member and prevent relative movement between the locking member and the showerhead engaging portion (see FIG. 10b). As shown in FIG. 8d, flange 20 on hub member 3 contains a race 42 corresponding generally in size and dimension to race 40 on the showerhead engaging portion. As in the case of race 37 on the tubular body portion, race 40 preferably includes along its bottom interior surface a series of teeth 43 that correspond to teeth 31 on the ratchet locking member. Accordingly, when the hub member is secured to the showerhead engaging portion, a biasing member 39 situated with race 40 will cause an engagement of teeth 31 on the ratchet locking member with teeth 43 on race 42 in the hub member. This will effectively lock the showerhead engaging portion (and hence also the showerhead) in position vis-a-vis the hub member until sufficient force is applied to overcome the biasing force that is applied to the two sets of teeth.

In essentially the same manner shower arm coupling 6 includes an internal race 44 having partitions 45 that together receive and prevent relative movement between the ratchet locking member and the shower arm coupling. When the coupling is secured to the end of the hub member a biasing member 39 will force an engagement of teeth 31 on the ratchet locking member with corresponding teeth 43 in the hub member to prevent rotational movement of the coupling about the hub until sufficient force is applied to overcome the biasing force that drives the two sets of teeth together.

It will thus be appreciated that the structure of the ratchet locking member described above will permit relative rotational movement of the various parts of showerhead extension arm 1 by fixed and incremental amounts or degrees when sufficient force is applied in order to overcome the biasing force applied to the locking member.

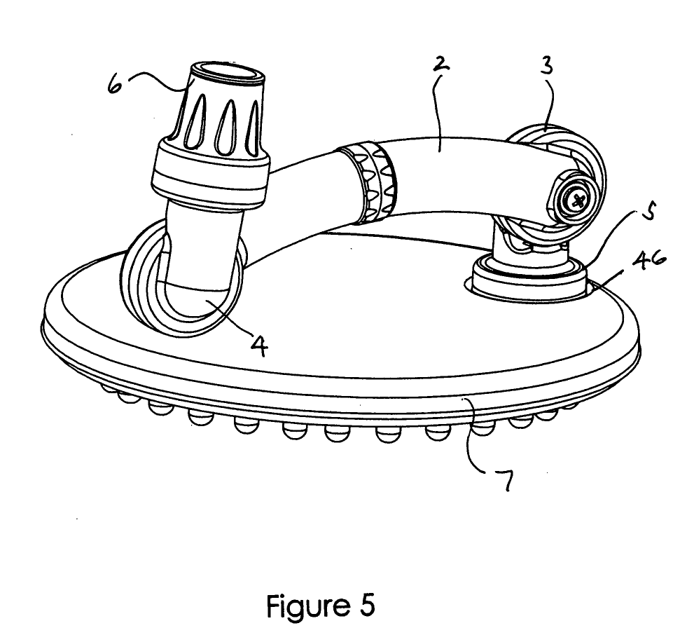

From a thorough understanding of the invention as described and shown herein, one of ordinary skill in the art will appreciate that showerhead extension arm I permits a large degree of freedom with respect to the movement and positioning of a showerhead secured thereto on account of the multiple axes of rotation that are provided between the various component parts that make up the extension arm. Some of the positions that the showerhead may be adjusted to are shown in FIGS. 1, 2a, 2b, 3 and 5, however, numerous other positions are also achievable. As is also shown in the attached drawings, to maximize the flexibility of the movement of the showerhead about both the shower arm extension and within the shower stall, water inlet 46 is preferably offset from the center or the central portion of the showerhead, and most preferably positioned at or near the edge on the showerhead's rear surface. Doing so permits the showerhead to be raised or lowered by a greater degree, and also allows the showerhead to effectively be folded back onto the showerhead extension arm (see FIG. 5) to minimize intrusion of the showerhead into the shower stall or enclosure.

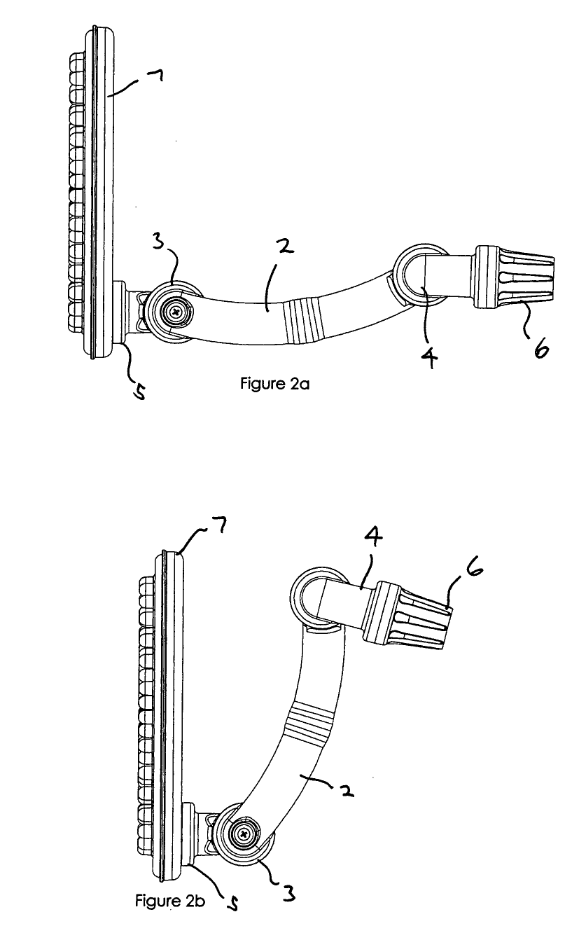

In addition, and as noted above, in one embodiment of the invention tubular body portion 2 is slightly curved or arcuate in shape (see FIGS. 2a and 2b). Forming the tubular body portion in this manner provides the added advantage of further enhancing the possible positioning of the showerhead within the shower stall. In particular, the curved or arcuate tubular body portion permits the showerhead to be placed in a generally horizontal position at an elevation above the position of the water supply conduit extending through the shower wall. It will be appreciated that if the tubular body portion were straight and not curved the showerhead could not be oriented in a generally horizontal plane at as high an elevation as in the case where the tubular body portion is curved, since the showerhead would come into contact with the straight tubular body. In a similar fashion, the curved body portion also permits the showerhead to be oriented in a generally horizontal plane at an elevation below water supply conduit 53 when used by shorter individuals or children.

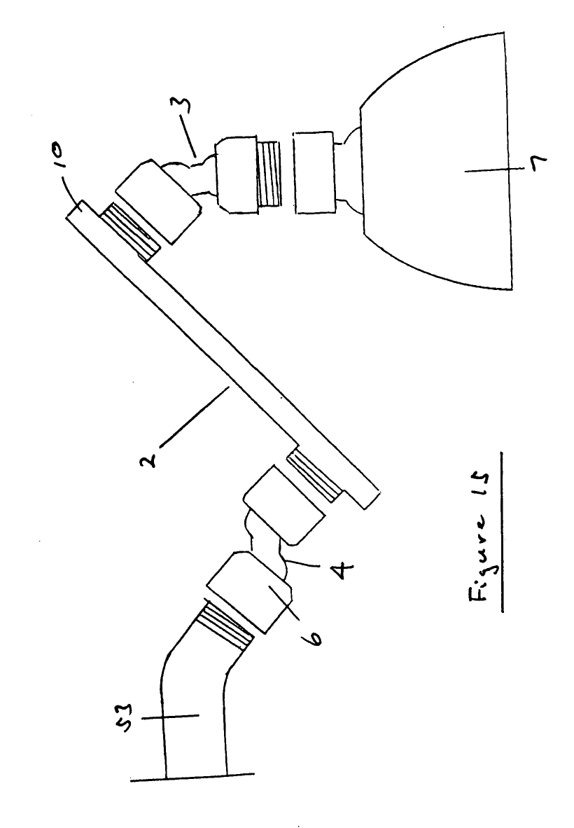

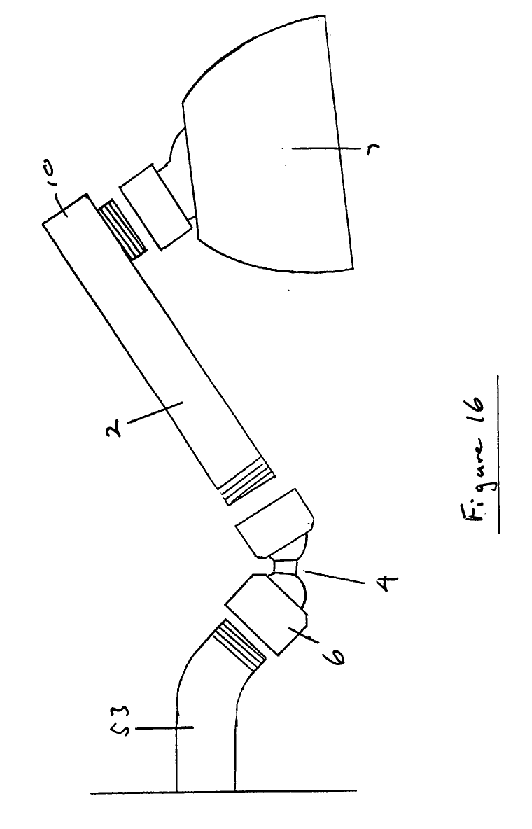

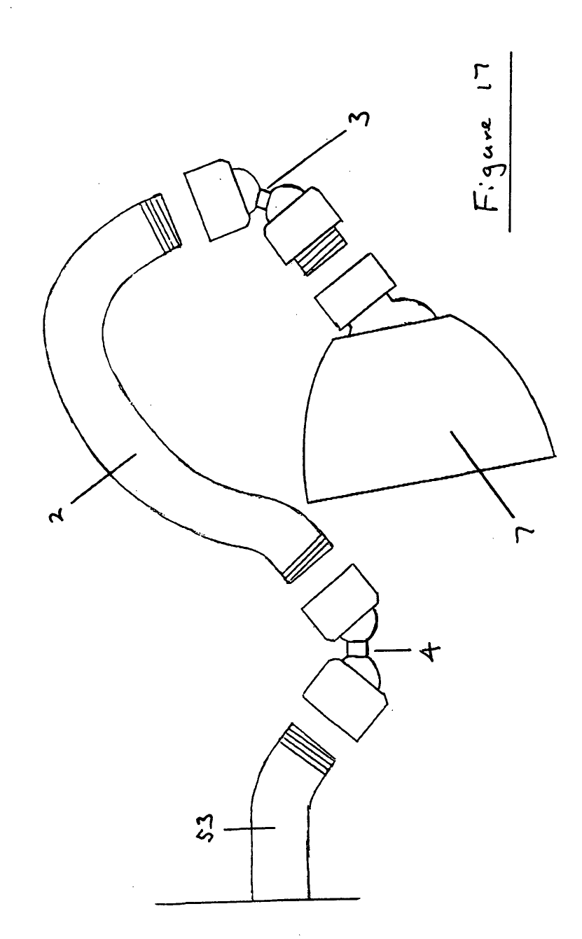

FIGS. 15 through 17 show alternate embodiments of the invention that permit the movement of the showerhead and the extension arm in manners as described above. In FIG. 15 first and second hub members 3 and 4 are double acting or double swivel ball joints. Here the operation of the combination of two double acting ball joints permits the showerhead to be positioned in locations that would not otherwise be possible through the use of conventional extension arms. In FIG. 16 second hub member 4 is a double swivel ball joint with showerhead 7 being threaded directly onto first end 10 of tubular body portion 2. Unlike existing extension arms, in the embodiment of FIG. 16 the showerhead is connected to the main tubular body at a generally right angle to the axis of the tubular body. It will be appreciated that in this manner the structure once again permits an enhanced range of movement for the showerhead. FIG. 17 shows an embodiment of the invention where first and second hub members 3 and 4 are double acting or double swivel ball joints and the tubular body is generally C-shaped. As described above, the use of a curved, or in this case a generally C-shaped, tubular body assists in the ability to position the showerhead in a horizontal plane when it is elevated or lowered with respect to the location of water supply conduit 53.

It is to be understood that what has been described are the preferred embodiments of the invention and that it may be possible to make variations to these embodiments while staying within the broad scope of the invention. Some of these variations have been discussed while others will be readily apparent to those skilled in the art. For example, while in the enclosed drawings showerhead engaging portion 5 is shown as being rigidly fixed to the rear surface of the showerhead, in an alternate embodiment the showerhead engaging portion may include a threaded nipple to effectively allow the showerhead extension arm to be threaded on to the back of a standard or traditional showerhead. In addition, while in the described embodiment the shower arm coupling contains an internal threaded bore for threading onto a water supply conduit, it will be appreciated that the coupling may instead be fitted or formed with a threaded nipple for receipt into an elbow or other fitting within the wall of the shower stall or enclosure. Further, it will also be appreciated that the use of ratchet locking members will be only but one manner of holding the showerhead in its desired position. Alternately, wing nuts or other forms of locking nuts could be used while remaining within the broad scope of the invention.

I claim:

1. A showerhead extension arm comprising:
(i) a generally tubular body portion having an internal passageway to permit the flow of fluid therethrough;
(ii) first and second hub members, said first hub member rotationally secured to a first end of said tubular body portion and said second hub member rotationally secured to a second end of said tubular body portion, each of said hub members permitting the flow of fluid therethrough;
(iii) a showerhead engaging portion rotationally secured to said first hub member and permitting said showerhead extension arm to be secured to a showerhead such that said showerhead is permitted to rotate relative to an axis generally perpendicular to said tubular body portion and to simultaneously rotate relative to an axis generally parallel to said tubular body portion; and,
(iv) a shower arm coupling rotationally secured to said second hub member and releasably securing said extension arm to a water supply conduit such that water from said conduit is permitted to flow through said shower arm coupling, through said second hub member, through said tubular body portion, through said first hub member, through said showerhead engaging portion and into said shower head.

2. The device as claimed in claim 1 wherein each of said first and said second hub members includes a ratchet locking member-permitting said hub members to rotate relative to an axis generally perpendicular to the longitudinal axis of said tubular body portion by fixed and incremental amounts.

3. The device as claimed in claim 1 wherein said shower arm coupling includes a ratchet locking member permitting rotation of said shower arm coupling, relative to an axis generally perpendicular to the axis of rotation of said second hub member about said tubular body portion, by fixed and incremental amounts.

4. The device as claimed in claim 1 wherein said showerhead engaging portion includes a ratchet locking member permitting rotation of said showerhead, relative to an axis generally perpendicular to the axis of rotation of said first hub member relative to said tubular body portion, by fixed and incremental amounts.

5. The device as claimed in claim 1 wherein said showerhead engaging portion is rotatably securable to a water inlet on said showerhead, said water inlet offset from the center or the central portion of said showerhead.

6. The device as claimed in claim 1 wherein said showerhead engaging portion includes a threaded nipple for securing said extension arm to said showerhead.

7. The device as claimed in claim 1 wherein said shower arm coupling includes a threaded bore permitting said shower arm coupling to be threadably secured to said water supply conduit.

8. The device as claimed in claim 2 wherein said ratchet locking members of said first and said second hub members include biasing members to maintain said hub members in a locked position such that rotation of said first and said second hub members relative to said tubular body portion requires the application of force sufficient to overcome the biasing force of said biasing members.

9. The device as claimed in claim 3 wherein said ratchet locking member of said shower arm coupling includes a biasing member to maintain said shower arm coupling in a locked position such that rotation of said shower arm coupling about an axis generally perpendicular to the axis of rotation of said second hub member about said tubular body portion requires the application of force sufficient to overcome the biasing force of said biasing member.

10. The device as claimed in claim 4 wherein said ratchet locking member of said showerhead engaging portion includes a biasing member to maintain said showerhead engaging portion in a locked position such that rotation of said showerhead engaging portion about an axis generally perpendicular to the axis rotation of said first hub member about said tubular body portion requires the application of force sufficient to overcome the biasing force of said biasing member.

11. The device as claimed in claim 1 wherein said tubular body portion is curved or arcuate.

12. A showerhead extension arm for connecting a showerhead to a water supply conduit, the showerhead extension arm comprising:
(i) a generally tubular body portion having an internal passageway to permit the flow of water therethrough;
(ii) first and second hub members, said first hub member rotationally secured to a first end of said tubular body portion to permit rotation of said first hub member relative to axis generally perpendicular to the longitudinal axis of said tubular body portion, said second hub member rotationally secured to a second end of said tubular body portion to permit rotation of said second hub member relative to axis generally perpendicular to the longitudinal axis of said tubular body portion;
(iii) a showerhead engaging portion to secure said showerhead to said first hub member and permitting said showerhead to rotate relative to axis generally perpendicular to the axis of rotation of said first hub member about said tubular body portion; and,
(iv) a shower arm coupling releasably securable to said water supply conduit and rotationally secured to said second hub member to permit rotation of said shower arm coupling relative to an axis generally perpendicular to the axis of rotation of said second hub member about said tubular body portion.

13. The device as claimed in claim 12 wherein water from said water supply conduit is permitted to flow through said shower arm coupling, through said second hub member, through said tubular body portion, through said first hub member, through said showerhead engaging portion and into said showerhead.

14. The device as claimed in claim 12 wherein each of said first and said second hub members include a locking ratchet member permitting said hub members to rotate relative to said axes generally perpendicular to the longitudinal axis of said tubular body portion by fixed and incremental amounts.

15. The device as claimed in claim 14 wherein said ratchet locking members include biasing members to independently maintain said first and second hub members in a locked position such that rotation of each of said hub members relative to said tubular body portion requires the application of force sufficient to overcome the biasing force of said biasing members.

16. The device as claimed in claim 12 wherein said shower arm coupling includes a ratchet locking member permitting the rotation of said shower arm coupling relative to said second hub member by fixed and incremental amounts.

17. The device as claimed in claim 16 wherein said ratchet locking member includes a biasing member to maintain said shower arm coupling in a locked position such that rotation of said shower arm coupling relative to said second hub member requires the application of force sufficient to overcome the biasing force of said biasing member.

18. The device as claimed in claim 12 wherein said showerhead engaging portion includes a ratchet locking member permitting rotation of said showerhead relative to said first hub member by fixed and incremental amounts.

19. The device as claimed in claim 18 wherein said ratchet locking member includes a biasing member to maintain said showerhead engaging portion in a locked position such that rotation of said showerhead relative to said first hub member requires the application of force sufficient to overcome the biasing force of said biasing member.

20. The device as claimed in claim 12 wherein said showerhead has a water inlet offset from the center or the central portion of the rear surface of said showerhead.

21. The device as claimed in claim 12 wherein said tubular body portion is curved or arcuate.

22. A showerhead extension arm for connecting a showerhead to a water supply conduit, the showerhead extension arm comprising:
(i) a generally tubular body portion having an internal passageway to permit the flow of water therethrough;
(ii) a showerhead engaging portion to secure said showerhead to said tubular body portion,
(iii) a hub member secured to said tubular body portion; and,
(iv) a shower arm coupling releasably securable to said water supply conduit and rotationally secured to said hub member, said hub member and said shower arm coupling together permitting the simultaneous rotation of said tubular body member, and said showerhead attached thereto, relative to both an axis that is generally perpendicular to the longitudinal axis of said tubular body portion and relative to an axis that is generally parallel to the longitudinal axis of said tubular body portion.

23. The device as claimed in claim 22 including a second hub member secured to said tubular body portion, said showerhead engaging portion securing said showerhead to said second hub member to permit rotation of said showerhead relative to both an axis that is generally perpendicular to the longitudinal axis of said tubular body portion and relative to an axis that is generally parallel to the longitudinal axis of said tubular body portion.

24. The device as claimed in claim 22 wherein said hub member is a double swivel ball joint.

25. The device as claimed in claim 23 wherein said hub member and said second hub member are double swivel ball joints.
